(19) United States
(12) Patent Application Publication
(10) Pub. No.: US 2016/0092511 A1
(43) Pub. Date: Mar. 31, 2016

(54) INTERACTIVE CONSTRUCTION OF QUERIES

(71) Applicant: LinkedIn Corporation, Mountain View, CA (US)

(72) Inventors: Zhifang Liu, Sunnyvale, CA (US); Steven Foote, Santa Clara, CA (US); Daniel Tunkelang, Mountain View, CA (US); Ashley Woodman Hall, Menlo Park, CA (US); Asif Mansoor Ali Makhani, Fremont, CA (US)

(21) Appl. No.: 14/500,633

(22) Filed: Sep. 29, 2014

(51) Int. Cl. G06F 17/30; H04L 29/08

(52) U.S. Cl. CPC G06F 17/30477; G06F 17/30554; H04L 67/30

(57) ABSTRACT

Method and system to assist a user in formulating a search query is described. The system may provide suggested entities, entity types, and relationship operators to a user and interactively build a complex structured query. Complex structured queries may include a combination of one or more entities and entity types, together with one or more relationship operators.

### TECHNICAL FIELD

This application relates to the technical fields of software and/or hardware technology and, in one example embodiment, to system and method to assist a user in formulating a search query.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. A member profile in an on-line social network system may also represent a group, a company, a school, etc. Member profiles in an on-line social network system may be referred to as simply profiles.

An on-line social network system may include a search system that permits members to search information, such as, e.g., jobs postings, people, etc., within an on-line social network. The searches within the on-line social network may be viewed as navigational (where the intent of the search—search intent—is to locate a specific item, e.g., a particular person) or exploratory (where the intent of the search is to scan through the available information in order to identify potentially interesting or useful items). A navigational search may be fairly specific (e.g., indicating the first and last name of a person). An exploratory search, on the other hand, may return a great number of search results, which may sometimes make it difficult to identify those search results that are most useful. A search system may process a search request by matching a search string against the stored content to determine, which documents or records contain the search string. The documents that contain the search string, or references to those documents, are returned as search results. A search system may obtain a search string, e.g., by accessing input provided by a user via a search box presented as part of Graphical User Interface (GUI).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to assist a user in formulating a search query may be implemented;

FIG. 2 is block diagram of a system to assist a user in formulating a search query, in accordance with one example embodiment;

FIG. 3 is a flow chart of a method to assist a user in formulating a search query, in accordance with an example embodiment;

FIG. 4 is a flow chart illustrating further details of a method to assist a user in formulating a search query, in accordance with an example embodiment;

FIG. 5-12 are example screens illustrating the guidance process to assist a user in formulating a search query, in accordance with an example embodiment; and

FIG. 13 is a diagrammatic representation of an example machine in the form of a computer system within which a set of instructions, for causing the machine to perform any one or more of the methodologies discussed herein, may be executed.

### DETAILED DESCRIPTION

A method and system to assist a user in formulating a search query in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” it will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.).

The profile of a member may also include information about the member's current and past employment, such as company identifications, professional titles held by the associated member at the respective companies, as well as the member's dates of employment at those companies. A professional title that may be present in a member profile and indicate a professional position of the member during a particular period of employment may be referred to as a title string. Thus, a title string that appears in a member profile may be associated with a particular company and also with a period of time during which the member held, at that company, a particular position.

As mentioned above, an on-line social network system may include a search system that permits members to search for a wide range of information. In one embodiment, a search system may be configured to generate structured queries using one or more techniques described below. Method and system are described for assisting users in the process of formulating search criteria and generating so-called structured queries (also referred to as compound graph queries). A query that is processed by matching one or more keywords against the entire content of a document or a record may be referred to as an unstructured query, A structured query, on the other hand, is a query that is processed by examining some but not all fields in a document to determine whether the content stored in those one or more selected fields contains a search string included in the query. A structured query that is processed by examining some but not all fields in a document may be referred to as a fielded query. A fielded query includes a string that is identified by the search system as an entity of a particular entity type. The search system is then able to determine whether that particular entity type is associated with one or more specific fields in the collection of documents and, if so, search only those specific fields in the documents from the collection. Strings that have been tagged with or identified as being of a particular entity type are entities of that particular entity type. For example, a string “Michael Smith” may be identified by the search system as an entity of type “people.” A string “LinkedIn” may be identified by the search system as an entity of type “companies.”

Another example of a structured query is a so-called faceted query, where, rather than matching text, a search system matches identifiers (ID's). For example, an entity of type “companies” may be a string “LinkedIn,” which also has an ID. In the member profiles, the company that corresponds to the “LinkedIn” string has the same ID. When a user requests a search for “LinkedIn,” the search system determines the ID assigned to the “LinkedIn” string and matches the ID assigned to the “LinkedIn” string with IDs stored in the member profiles. For example, if the entity “LinkedIn” is assigned company ID 1337 in the on-line social network system, a query including the entity “LinkedIn” would result in the search system returning member profiles that are assigned 1337 as an ID in the Current Company facet associated with the profiles.

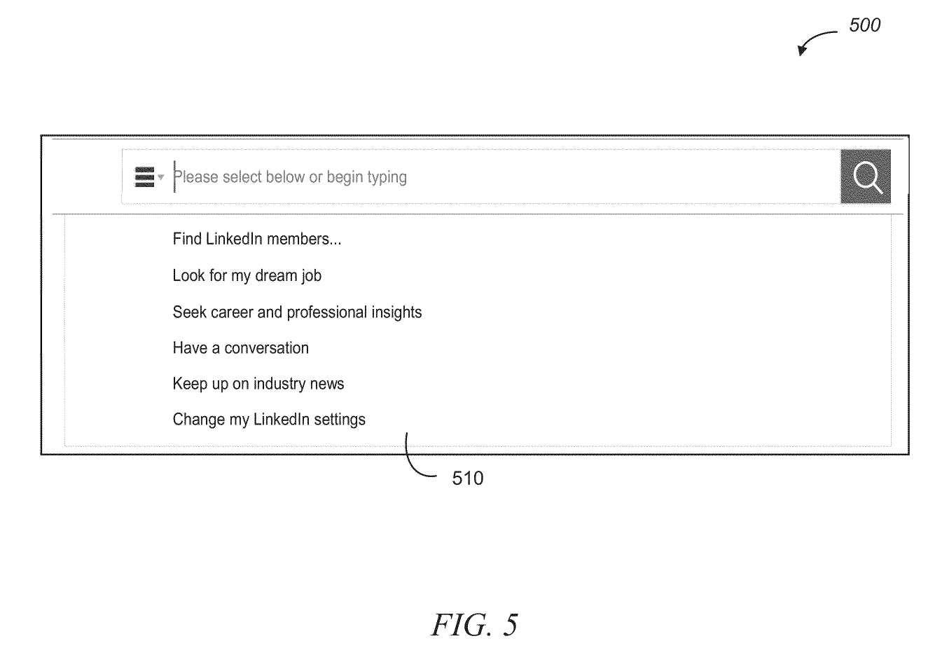

A search system may obtain a search string, e.g., by accessing input provided by a user via a search box presented as part of Graphical User Interface (GUI). In one embodiment, a search system may be configured to assist and guide a user in building complex structured queries that may include a combination of one or more entities and entity types, together with one or more relationship operators. Thus configured search system may initiate the guidance process by first attempting to determine so-called search intent. In response to detecting activation of a search box (e.g., detecting a cursor placed in the search box), the search system causes presentation of one or more search intent options, such as, e.g., “Find LinkedIn members,” “Look for my dream job,” etc. on the display device of the user. An example presentation of suggested search intent options is shown on screen 500 in FIG. 5.

In one embodiment, the initial list of search intent options may be personalized based on the information about the user that the search system may glean from the member profile information associated with the user and the related information (e.g., user's activities in the context of the on-line social network system, information based on data available with respect to the user's connections in the on-line social network system, etc.) The personalization aspect of the search system may be referred to as member understanding process. Thus generated personalized presentation of the search intent options may influence what entities or entries are being suggested to the user by the search system and also influence which relationship operators are being suggested to the user by the search system, based on the likely goals derived by the search system from the search intent option selected by the user. It will be noted, that a pre-query search intent selection by the user is not required for the search system to proceed with assisting and guiding a user in formulating a search request and in the resulting query construction.

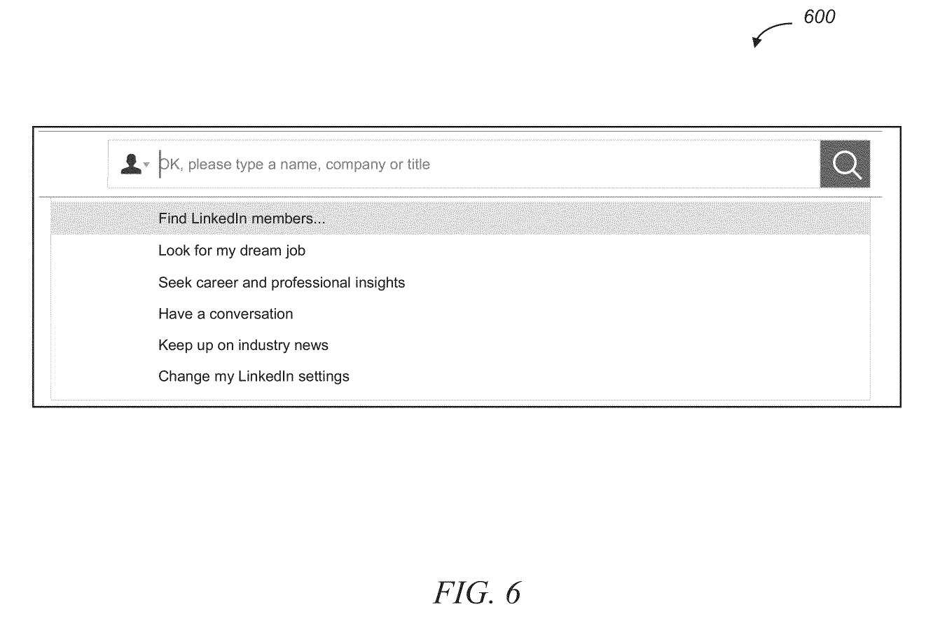

The user may then either type one or more keywords into the search box and submit e search or select one of the search intent options presented in the area 510 shown in FIG. 6. If the user selects one of the search intent options, e.g.,

“Find LinkedIn members,” as shown on screen 600 of FIG. 6, the search system may present text in the search box—termed a ghost text prompt—instruction the user to type a name, company or title. Each of the search intent options presented by the search system to the user may be associated with one or more entity types. Thus, the search system may be configured to treat a string that is typed into the search box subsequent to the selection of a search intent option as an entity of one of the entity types associated with the selected search intent options.

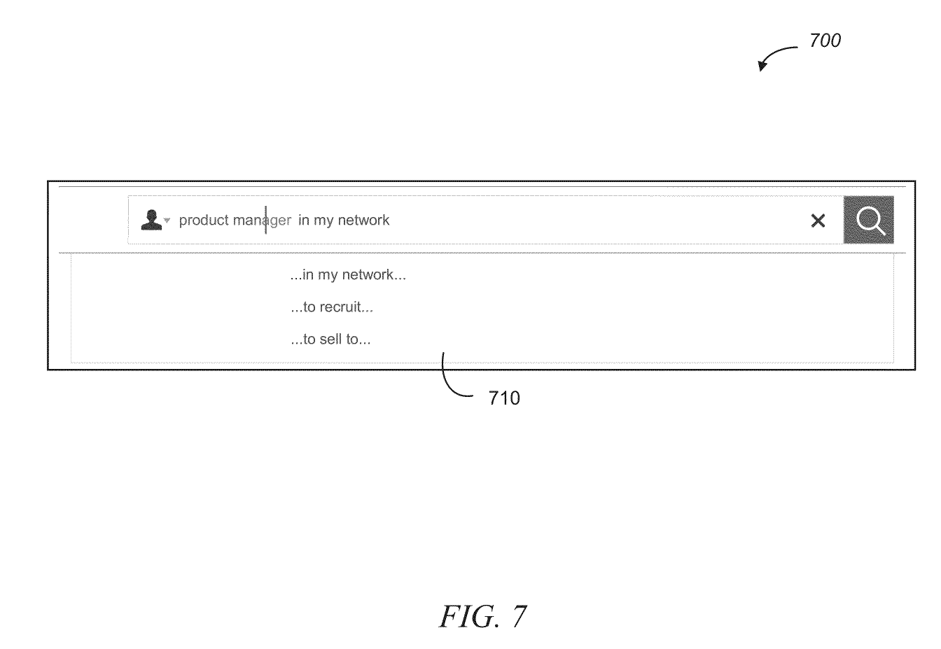

The search system recognizes the string typed into the search box as an entity and determines one or more relationship operators that are suitable for expressing a relationship with respect to the entity type associated with the entity. This is illustrated in FIG. 6, where the search box includes the string “product manager” (autocompleted by the search system from the string “product mana” typed in by the user) and also a relationship operator “in my network” suggested by the search system. As shown on screen 600 of FIG. 6, the search system, upon recognizing the auto-completed string “product manager” as an entity of a certain type (here an entity of type “title”), determines one or more relationship operators and/or intent operators suitable for expressing a relationship or an intent with respect to the entity type “title.” An example of a relationship operator is “in my network.” Examples of intent operators are “to recruit,” and “to sell to.” The intent operators may be utilized by the search system to capture the user's search intent during the query formulation process and to identify appropriate ways to respond to the user's search goal. The relationship operator “in my network” and intent operators “to recruit” and “to sell to” are presented on the display device of the user in area 710 shown in FIG. 7.

If the resulting query, expressed by the string “product manager in my network,” as shown in FIG. 7 is submitted for processing by the search system, the search system processes the query treating the string “product manager” as an entity of type “title” and treating the string “in my network” as a relationship operator. For example, as a result, the search system may examine only those profiles in the on-line social network system that represent people that are connected to the user via their respective profiles, and, in those profiles, examine only the section that is designated to store information related to the member's professional experience, in order to find matches with the string “product manager.”

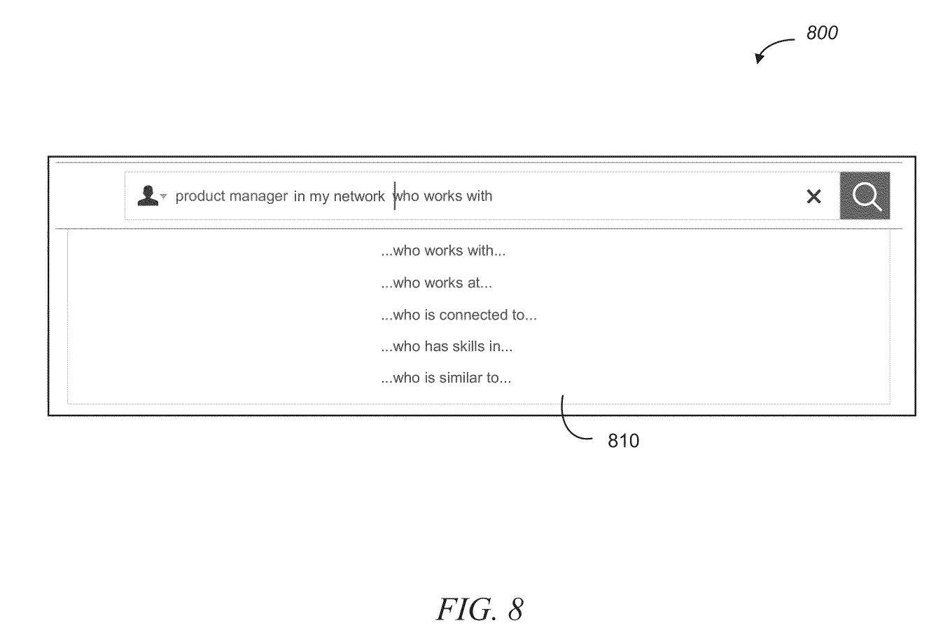

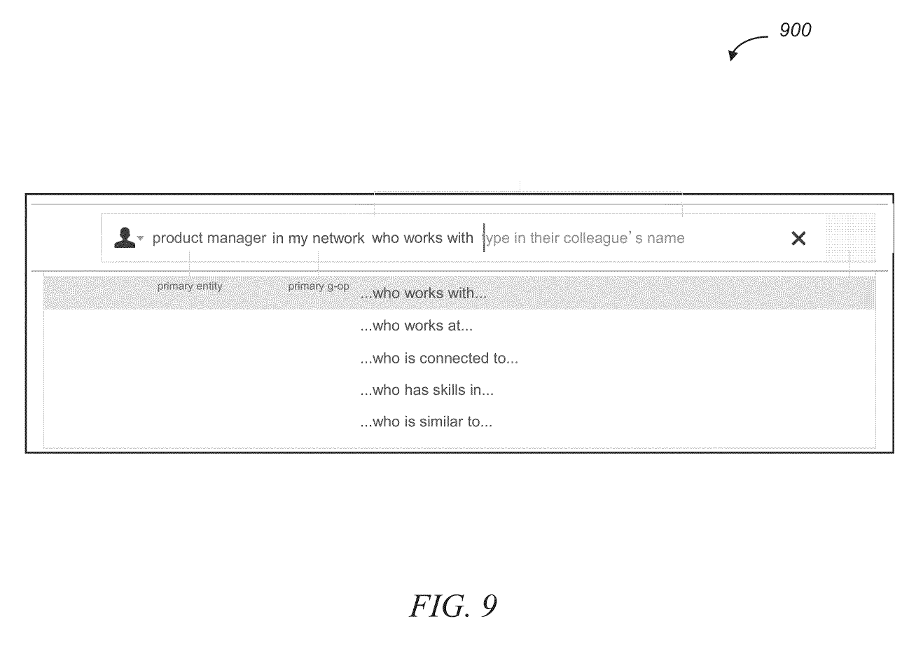

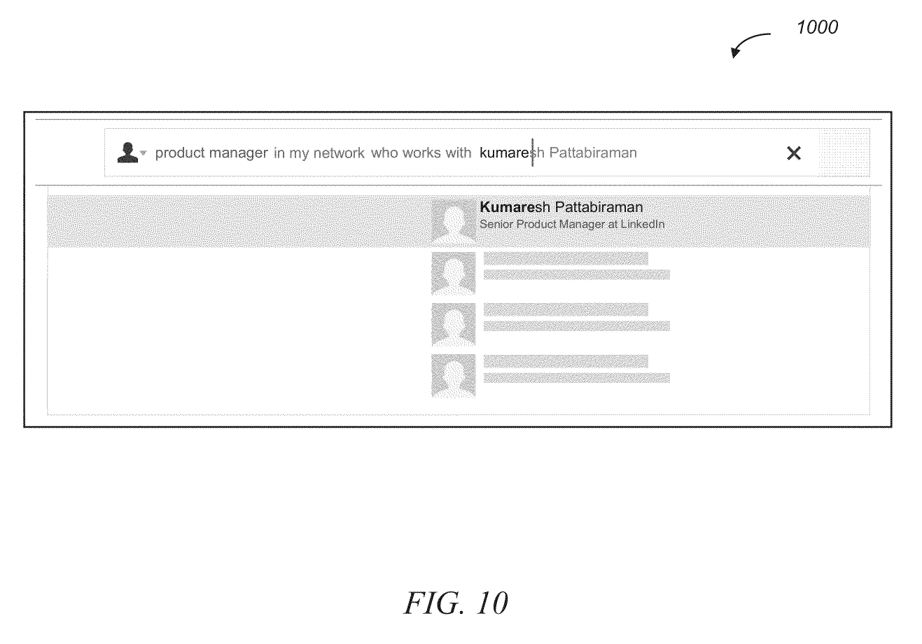

The search system continue the guidance process by presenting a further set of suggestions, e.g., a set representing one or more entity types or a set representing one or more relationship operators. As shown on screen 800 in FIG. 8, the search system may present further relationship operators, such as “and works with,” “who works with,” etc. The list of suggestions presented in area 810 in FIG. 8 may be determined based on the entity type of the entity represented by the string “product manager.” If the user selects one of the suggested relationship operators presented in area 810, the selected relationship operator is populated into the search box and the search system provides in instruction to the user with respect to how to proceed with building the query. As shown on screen 900 in FIG. 9, the instruction provided by the search system reads “type in their colleague's name.” In order to generate this instruction, the search system may be configured to analyze the entity corresponding to the string “product manager”, the two relationship operators included in the search box, and apply one or more business rules. The user may then enter a string representing a person's name, which may be autocompleted by the search system, as shown on screen 1000 in FIG. 10.

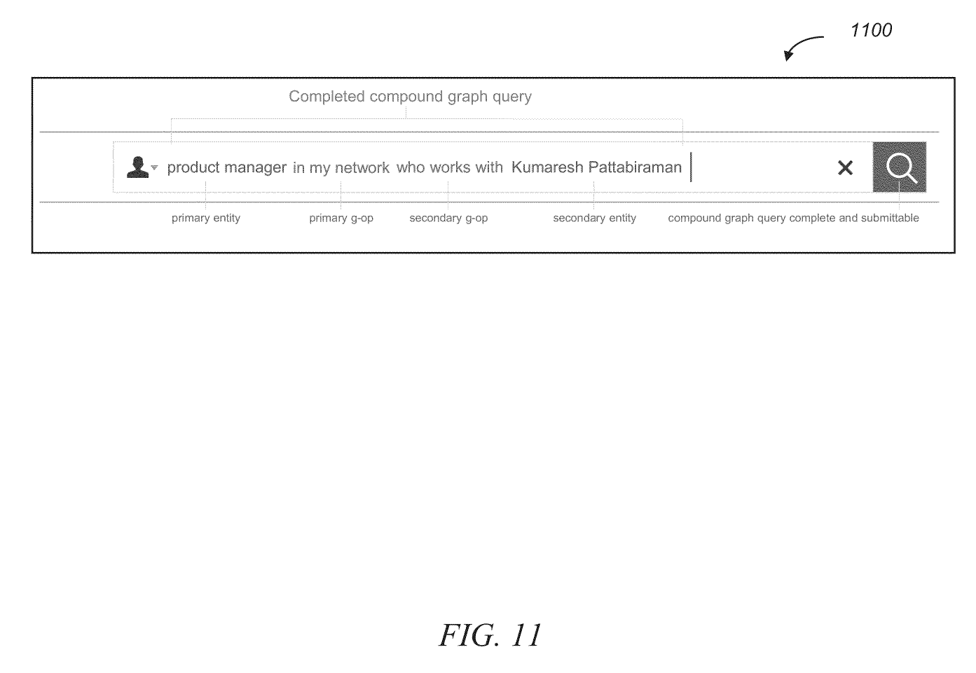

The result of the guidance process performed by the search system is a query that includes two entities and two relationship operators, as shown in screen 11 of FIG. 11. In one embodiment, entity types, entities, and relationship operators may be stored as cross-linked indexes. For example, an entity of type “company” may have a company name as its value. The company name value may be mapped to a table, where the entries include references to profiles representing those members of the on-line social network who are employees of the company identified by the company name.

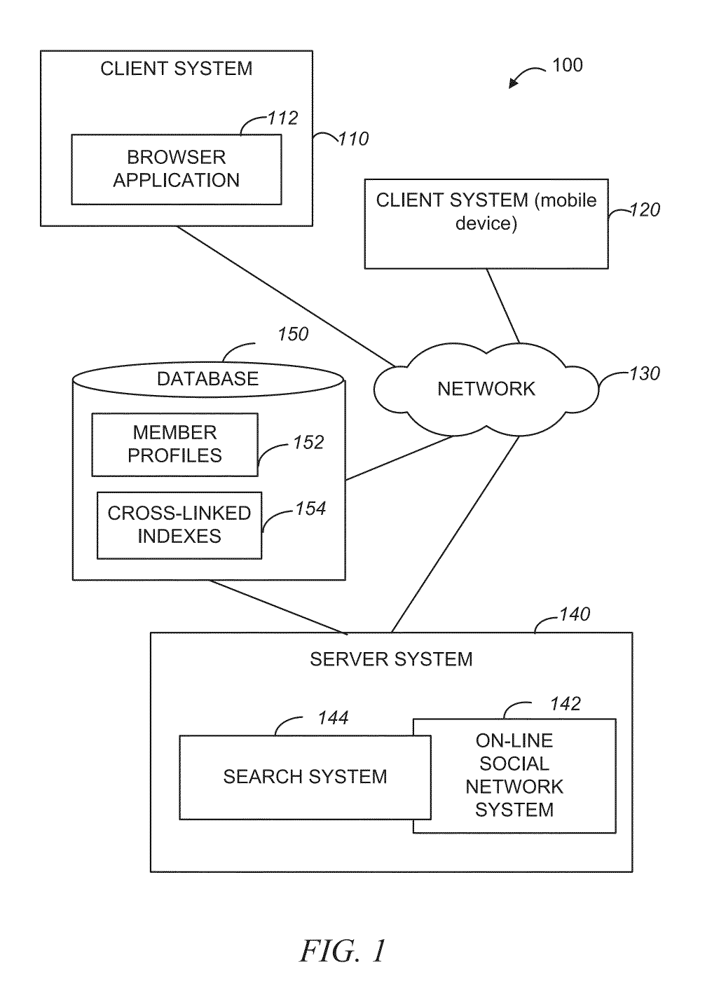

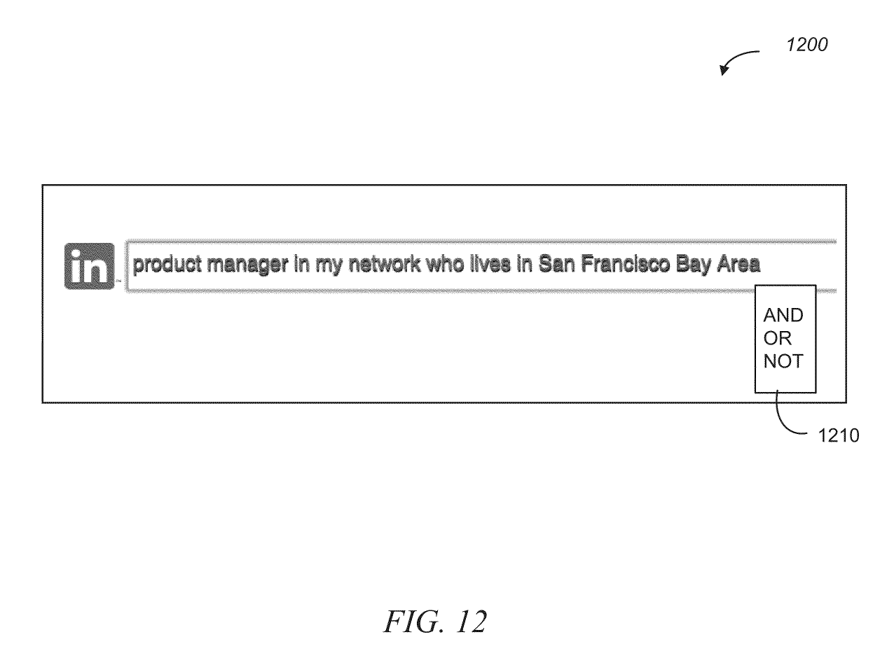

In one embodiment, the search system may also utilize and provide as suggestions Boolean operators, e.g. after the last entity has been selected by a user, in order to permit a user to add additional entities of the same type as well as follow-on relationship operators and entities. An example of presenting suggestions in the form of Boolean operators is shown in screen 1200 of FIG. 12 in area 1210. Example method and system to assist a user in formulating a search query may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 may also store entity types, entities, and relationship operators as cross-linked indexes 152.

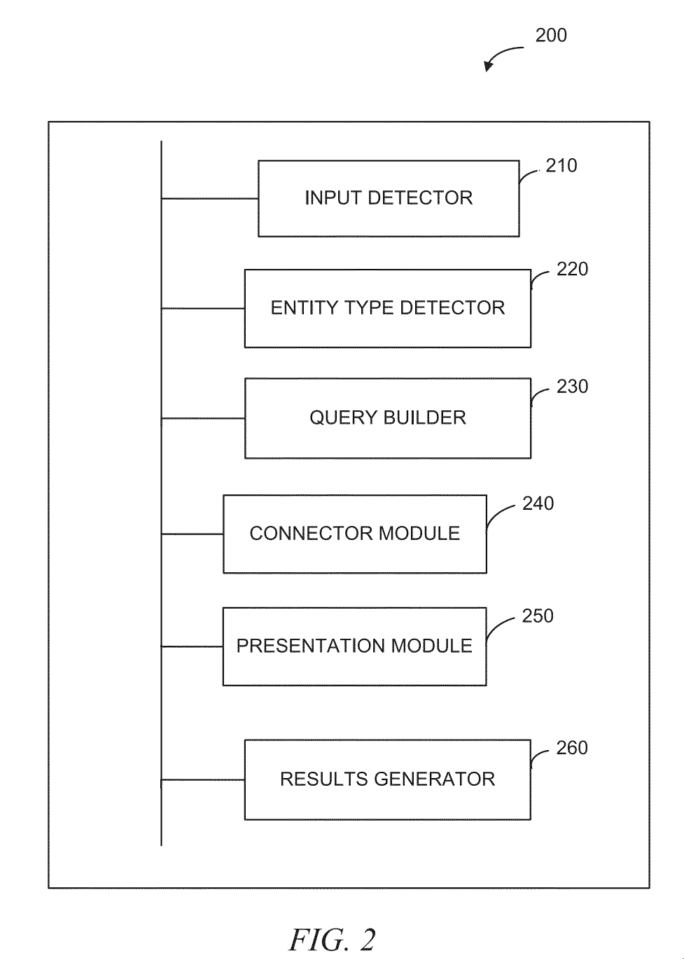

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search system 144 that may be utilized beneficially to aid users in formulating a search request and building a structured query. The search system 144 may be configured to assist and guide a user in building complex structured queries that may include a combination of one or more entities and entity types, together with one or more relationship operators, as described above. An example search system 144 is illustrated in FIG. 2.

FIG. 2 is a block diagram of a system 200 to assist a user in formulating a search query, in accordance with one example embodiment. As shown in FIG. 2, the system 200 includes an input detector 210, an entity type detector 220, a query builder 230, a connector module 240, and a presentation module 250. The input detector 210 may be configured to detect an input string in a search box, which may be presented on a display device as part of a user interface of a computing application. The computing application may maintain a plurality of profiles stored in the database 150 of FIG. 1 and may be the on-line social networking system 142 of FIG. 1. The entity type detector 220 may be configured to determine an entity type for an input string. The entity type detector 220 may also be configured to autocomplete the input string and to determine that the resulting entity string corresponds to an entity of a certain entity type. The entity type detector 220 may also utilize historical information with respect to searches against the plurality of profiles maintained by the on-line social network system 142.

The query builder 230 may be configured to include an entity corresponding to the input string into a query as part of the process of building a structured query. A structured query may include one or more entities of the same or different entity types, and one or more relationship operators. A relationship operator may indicate a relationship with an entity of a certain entity type. An entity type identifies a group of profiles from the plurality of profiles that are grouped based on predetermined criteria. For example, an entity type may be associated with profiles that represent respective companies. A relationship operator may indicate relationships, such as current employment of a person represented by an entity at a company represented by another entity. Another relationship operator may indicate past employment of a person represented by an entity at a company represented by another entity. The connector module 240 may be configured to determine a relationship operator suitable for expressing a relationship with an entity of the entity type. The presentation module 250 may be configured to cause presentation, on a display device, a query suggestion as a link for activation of the structured query.

The input detector 210 may be configured to detect a selection of a relationship operator presented on the display device and also detect a further input string in the search box. The entity type detector 220 may then identify the further input string as being of a further entity type, and the query builder may append, to the query, the relationship operator and a further entity corresponding to the further input string to the query (the further entity being of the further entity type). the resulting query is a complete query and is submitted for processing, a results generator 260, also included in the system 200, may process the query and generate one or more search results. For example, in the query that corresponds to the string “product manager who works at LinkedIn,” the string “product manager” corresponds to an entity of type “title,” the string “LinkedIn” corresponds to an entity of type “company, and that the string “who works at” corresponds to a relationship operator. The results generator 250 may process this query by examining only those profiles in the on-line social network system that represent people (and not companies, or schools, etc.) and, in the profiles that represent people, only examine the profile sections that are designated by the on-line social network system 142 to store information indicative of the current employer of the member represented by the respective profile or to store information indicative of the current position of the member. The presentation module 250 may be configured is to cause presentation of the search results on a display device of the user who initiated the search.

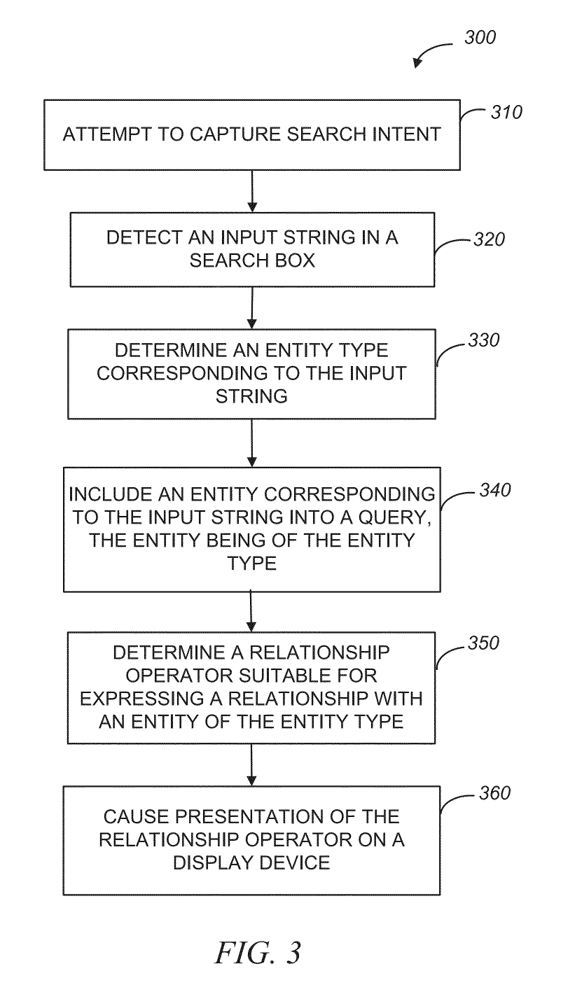

In one embodiment, the entity type detector 220 may be configured to obtain information indicative of search intent associated with the search and to utilize the search intent for determining the entity type corresponding to the input string. The presentation module 250 may be configured to cause presentation of one or more search intent options, each search intent option associated with a respective entity type, in response to detecting activation of the search box. Some operations performed by the system 200 may be described with reference to FIG. 3.

FIG. 3 is a flow chart of a method 300 to assist a user in formulating a search query, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the entity type detector 220 attempts to obtain information indicative of search intent associated with the search in response to detecting activation of a search box (e.g., in response to detecting a cursor placed in the search box). At operation 320, the input detector 210 of FIG. 2 detects an input string in the search box, which may be presented on a display device as part of a user interface of a computing application. At operation 330, the entity type detector 220 of FIG. 2 determines an entity type corresponding to the input string. At operation 340, the query builder 230 of FIG. 2 includes an entity corresponding to the input string into a query, the entity being of the determined entity type. At operation 350, the connector module 240 of FIG. 2 determines a relationship operator suitable for expressing a relationship with an entity of the entity type. At operation 360, the presentation module 240 of FIG. 2 causes presentation, on a display device, the determined relationship operator, which may be selected by a user for inclusion into the query.

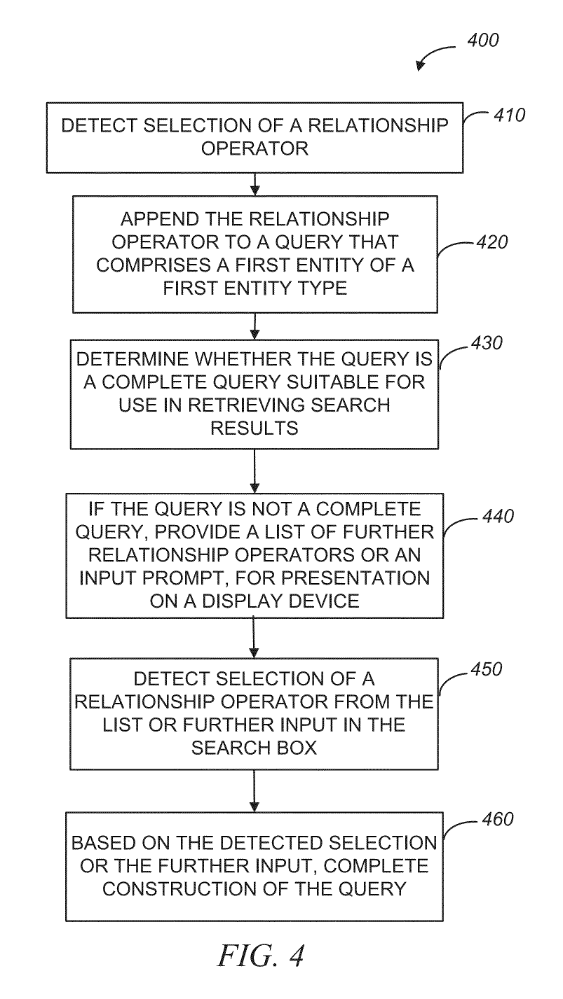

FIG. 4 is a flow chart of a method 400 that provides further details regarding assisting a user in formulating a search query, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 4, the method 400 commences at operation 410, when the input detector 210 of FIG. 2 detects a selection of a relationship operator presented on a display device of the user. At operation 420, the query builder 230 of FIG. 2 includes the selected relationship operator into the query that already includes an entity corresponding to the input string detected at operation 320 of FIG. 3. At operation 430, it is determined whether the resulting query is a complete query suitable for use in retrieving search results. If the resulting query is not a complete query, the connector module 240 of FIG. 2 determines a further relationship operator suitable for expressing a further relationship with the entity included in the query and the presentation module 240 of FIG. 2 causes presentation, on a display device, the determined further relationship operator, which may be selected by a user for inclusion into the query, at operation 440. Alternatively, the presentation module 240 may cause presentation of an input prompt in the search box, instructing the user to type in a particular type of information (e.g., “type in their colleague's name”), as shown in FIG. 9, which is described above. At operation 450, the input detector 210 of FIG. 2 detects a selection of the further relationship operator presented on a display device of the user or a further input in the search box. At operation 460, the query builder 230 of FIG. 2 completes the construction of the query.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

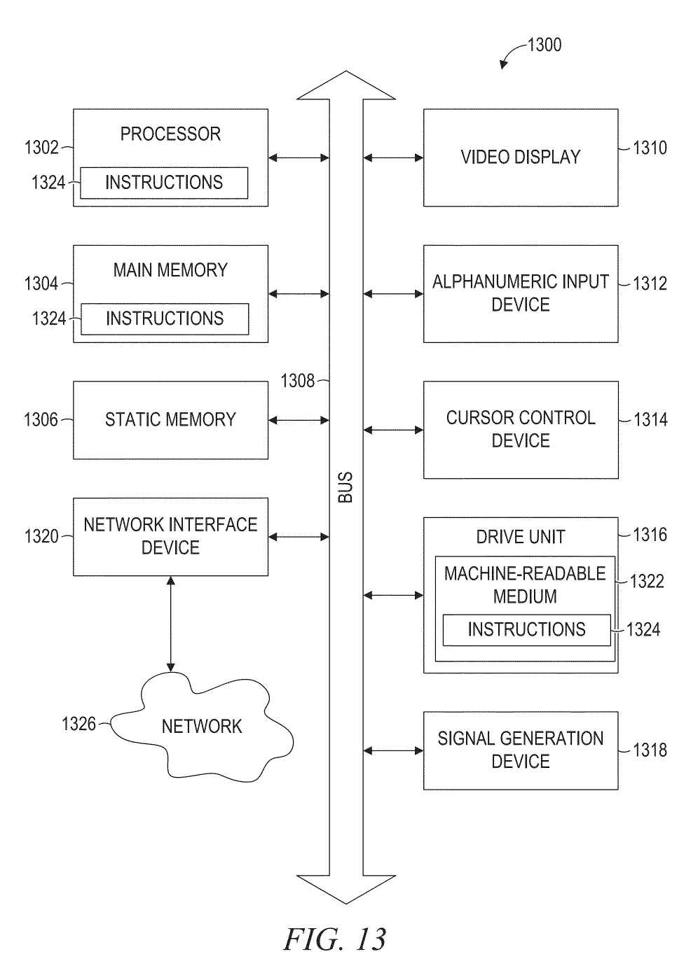

FIG. 13 is a diagrammatic representation of a machine in the example form of a computer system 1300 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1312. The computer system 1300 may further include a video display unit 1310 (e.g., a liquid crystal display (LCD) or a cathode ray tube (CRT)). The computer system 1300 also includes an alpha-numeric input device 1312 (e.g., a keyboard), a user interface (UI) navigation device 1314 (e.g., a cursor control device), a disk drive unit 1316, a signal generation device 1318 (e.g., a speaker) and a network interface device 1320.

The disk drive unit 1316 includes a machine-readable medium 1322 on which is stored one or more sets of instructions and data structures (e.g., software 1324) embodying or utilized by any one or more of the methodologies or functions described herein. The software 1324 may also reside, completely or at least partially, within the main memory 1304 and/or within the processor 1302 during execution thereof by the computer system 1300, with the main memory 1304 and the processor 1302 also constituting machine-readable media.

The software 1324 may further be transmitted or received over a network 1326 via the network interface device 1320 utilizing any one of a number of well-known transfer protocols (e.g., Hyper Text Transfer Protocol (HTTP)).

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually, or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to assist a user in formulating a search query have been described. While the techniques for formulating a search query have been described with reference to searches in the context of an on-line social network system, the method and system to assist a user in formulating a search query may be used beneficially in any context where electronic search results are being requested and retrieved. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting an input string in a search box, the search box presented on a display device as part of a user interface of a computing application, the computing application maintaining a plurality of profiles;
in response to the detecting, determining an entity type corresponding to the input string;
using at least one processor, including an entity corresponding to the input string into a query, the entity being of the determined entity type;
determining a relationship operator suitable for expressing a relationship with an entity of the entity type; and
causing presentation of the relationship operator on a display device.

2. The method of claim 1, comprising:
detecting a selection of the relationship operator;
appending the relationship operator to the query;
detecting further input string in the search box;
identifying the further input string as being of a further entity type;
appending a further entity corresponding to the further input string to the query, the further entity being of the further entity type;
processing the query to generate one or more search results, the query comprising: the entity, the further entity, and the relationship operator, the relationship operator expressing a relationship between the entity and the further entity.

3. The method of claim 2, comprising causing presentation, on the display device, of the search results.

4. The method of claim 1, wherein the determining of the entity type corresponding to the input string comprises obtaining information indicative of search intent associated with the input string.

5. The method of claim 4, wherein the determining of the entity type corresponding to the input string comprises: in response to detecting activation of the search box, causing presentation of one or more search intent options, each search intent option associated with a respective entity type.

6. The method of claim 1, wherein the determining of the entity type corresponding to the input string comprises generating an autocompleted version of the input string and determining the entity type based on the autocompleted version of the input string.

7. The method of claim 1, wherein the determining of the entity type corresponding to the input string comprises utilizing historical information with respect to searches against the plurality of profiles maintained by the computing application.

8. The method of claim 1, wherein the causing of the presentation of the relationship operator comprises causing the presentation of the relationship operator as one of a plurality of relationship operators, each operator from the plurality of relationship operators suitable for expressing a relationship with an entity of the entity type.

9. The method of claim 1, wherein a profile from the plurality of profiles represents one of a group consisting of a person, a company, and an educational institution.

10. The method of claim 1, wherein the application is an on-line social network system.

11. A computer-implemented system comprising:
an input detector, implemented using at least one processor, to detect an input string in a search box, the search box presented on a display device as part of a user interface of a computing application, the computing application maintaining a plurality of profiles;
an entity type detector, implemented using at least one processor, to determine, in response to the detecting, an entity type corresponding to the input string;
a query builder, implemented using at least one processor, to include an entity corresponding to the input string into a query, the entity being of the determined entity type;
a connector module, implemented using at least one processor, determining a relationship operator suitable for expressing a relationship with an entity of the entity type; and
a presentation module, implemented using at least one processor, to cause presentation of the relationship operator on a display device.

12. The system of claim 11, wherein:
the input detector is to detect a selection of the relationship operator and further input string in the search box;
the entity type detector is to identify the further input string as being of a further entity type;
the query builder is to append, to the query, the relationship operator and a further entity corresponding to the further input string to the query, the further entity being of the further entity type,
the system further comprising a results generator, implemented using at least one processor, to process the query and generate one or more search results, the query comprising: the entity, the further entity, and the relationship operator, the relationship operator expressing a relationship between the entity and the further entity.

13. The system of claim 112, wherein the presentation module is to cause presentation of the search results on the display device.

14. The system of claim 11, wherein the entity type detector is to obtain information indicative of search intent associated with the input string and to utilize the search intent for determining the entity type corresponding to the input string.

15. The system of claim 14, wherein the presentation module is to cause presentation of one or more search intent options, each search intent option associated with a respective entity type, in response to detecting activation of the search box.

16. The system of claim 11, wherein the entity type detector is to generate an autocompleted version of the input string and to determine the entity type based on the autocompleted version of the input string.

17. The system of claim 11, wherein the entity type detector is to utilize historical information with respect to searches against the plurality of profiles maintained by the computing application.

18. The system of claim 11, wherein the presentation module is to cause the presentation of the relationship operator as one of a plurality of relationship operators, each operator from the plurality of relationship operators suitable for expressing a relationship with an entity of the entity type.

19. The system of claim 11, wherein a profile from the plurality of profiles represents one of a group consisting of a person, a company, and an educational institution.

20. A machine-readable non-transitory storage medium having instruction data executable by a machine to cause the machine to perform operations comprising:
detecting an input string in a search box, the search box presented on a display device as part of a user interface of a computing application, the computing application maintaining a plurality of profiles;
in response to the detecting, determining an entity type corresponding to the input string;
including an entity corresponding to the input string into a query, the entity being of the determined entity type;
determining a relationship operator suitable for expressing a relationship with an entity of the entity type; and
causing presentation of the relationship operator on a display device.
